(19) United States
(12) Patent Application Publication
(10) Pub. No.: US 2004/0209606 A1
(43) Pub. Date: Oct. 21, 2004

(54) System, apparatus and method for managing incoming calls at a wireless device

(76) Inventors: James P. Cleary, San Diego, CA (US); Charles D. Gavrilovich JR., Chula Vista, CA (US); Mark M. Takahashi, San Diego, CA (US)

Correspondence Address: CHARLES D. GAVRILOVICH, JR.,, A PROFESSIONAL CORPORATION, 985 PASEO LA CRESTA, SUITE A, CHULA VISTA, CA, 91910-6729, US

(21) Appl. No.: 10/419,673

(22) Filed: Apr. 21, 2003

(51) Int. Cl. H04M 3/42

(52) U.S. Cl. 455/415; 455/416

(57) ABSTRACT

A preliminary answer message is transmitted to a calling device placing a call to a wireless device of a called party where the preliminary answer message indicates that the call has been accepted and the calling party will engage in communication after a period of time. When the calling party is alerted of the incoming call and can not currently speak, the calling party initiates the preliminary answer process through a user input on the wireless device. In response, the preliminary answer message, which may be a recorded voice message, is transmitted to the calling device and presented to the calling party.

### BACKGROUND OF THE INVENTION

The following description relates generally to communication systems and particularly to a system, apparatus and method for managing incoming calls at a wireless device.

The use of a wireless device, while allowing a user freedom of movement, can be intrusive and sometimes dangerous. A few examples of situations where the use of a wireless device may be inappropriate, rude to others, inconvenient, or dangerous include dining in a restaurant, attending a concert, attending a meeting, watching a movie in a movie theater, operating a vehicle, and engaging in face to face conversation.

Often, a called party using a wireless device faces having to accept a call in an inappropriate or dangerous situation because of the urgency or importance of the call. The called party may fear that the calling party will not call again, or will not leave a message on the called party's voice mail box, if their call is not immediately accepted and answered. Simply accepting a call, however, requires the called party to verbally alert the calling party that the call is accepted, usually prior to the called party removing himself from the inappropriate or dangerous situation. This verbal alert by the called party can be just as intrusive to third parties as a having conversation.

### BRIEF DESCRIPTION OF THE DRAWING

FIG. 1 is a block diagram of a communication system in accordance with an exemplary embodiment of the invention.

FIG. 2 is a block diagram of the preliminary answer processor in accordance with an exemplary embodiment.

FIG. 3 is block diagram of the communication system illustrating the wireless communication system portion of the communication system in accordance with the exemplary embodiment.

FIG. 4 is a flow chart of a method of managing an incoming call in accordance with an exemplary embodiment.

FIG. 5 is a flow chart of a method of managing incoming calls performed within the communication network in accordance with an exemplary embodiment.

FIG. 6 is a flow chart of a method of managing an incoming call performed at a wireless device in accordance with an exemplary embodiment.

FIG. 7 is a flow chart of a method of managing an incoming call in accordance with an exemplary embodiment of the invention where the call accepted message is stored in the wireless device.

### DETAILED DESCRIPTION OF THE PREFERRED EMBODIMENTS

In response to a user input, a preliminary answer message is transmitted to a calling device initiating the call, where the preliminary answer message indicates that the called party using the wireless device will participate in the call after a period of time. The invention may be implemented using any of numerous configurations utilizing any combination of software, hardware and firmware. For example, the preliminary answer message may be stored in the wireless device, in a base station, or any device connected within or to the communication system. Based on the teachings herein and in accordance with known techniques, those skilled in the art will recognize the other additional embodiments to the exemplary embodiments described in the following figures and description without departing from the scope of the invention.

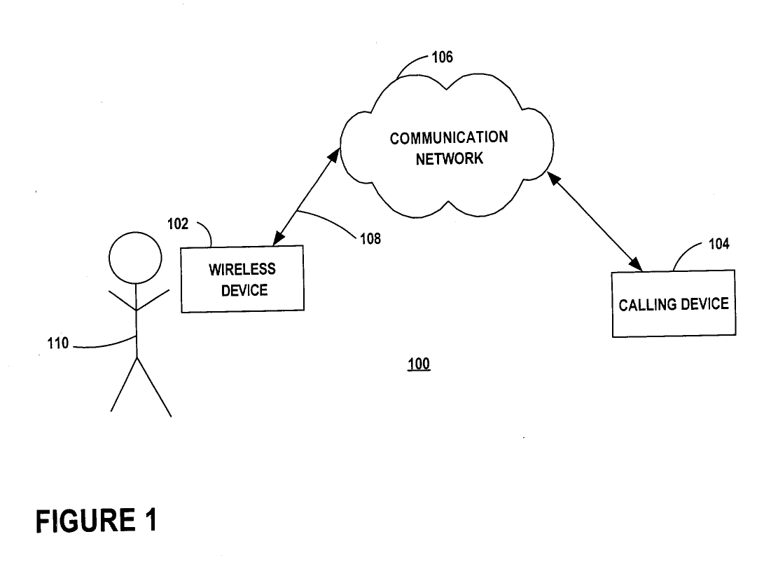

FIG. 1 is a block diagram of a communication system 100 in accordance with the exemplary embodiment. A calling party (not shown) places a call using a calling device 104 to a called wireless device 102 through a communications network 106. The calling device 104 is any device used to initiate a call for voice communications. For example, the calling device 104 may be a wired telephone, a cordless telephone, a wireless cellular telephone, a satellite phone, a video phone, a PDA having voice communication functionality, a computer or a computing device having voice telephony functionality, or any other device capable of placing a call through the communication network 106. The wireless device 102 is any device capable of receiving a call over a wireless link 108. For example, the wireless device 102 may be a cordless telephone, a two-way radio, a cellular telephone, a PDA having voice communication functionality, or any component or device having wireless voice communication capabilities.

The communication network 106 may comprise any combination of devices, components, systems, subsystems and networks that can be interconnected to enable communications between the calling device 104 and the wireless device 102, and includes at least one wireless link 108 which facilitates communication to and from the wireless device 102 in the exemplary embodiment. Accordingly, the communication network 106 may include any number of public switched telephone networks (PSTNs), fiber optic communication networks, private switched networks, analog cellular networks, digital cellular networks, Internets, Intranets, or other systems, hardware, software or firmware configured to provide communication services.

A calling party operates the calling device 104 to place a call to the wireless device 102. In the exemplary embodiment, the call is placed using the appropriate protocols and signaling in accordance with known techniques. A call indicator signal is transmitted through the wireless link 108 indicating that an incoming call has been initiated to the wireless device 102. The call indicator signal is any signal, message or combination of signals or messages exchanged with the wireless device 102 that indicates a call is being placed to the particular wireless device 102. In response to the call indicator, the wireless device 102 performs one of several actions depending on user settings. In the exemplary embodiment, the called party 110 programs user settings into the wireless device 102 indicating whether the wireless device 102 should alert the called party 110 or automatically invoke the preliminary answer procedure and simultaneously alert the called party 110. Where the wireless device 102 is configured to only alert the called party 110, the wireless device 102 continues to provide alert indicators until the called party 110 answers the call, the calling party terminates the calling attempt, or the called party 110 invokes the preliminary answer procedure. Any one of several alert indicators can be provided to the called party 110 in accordance with known techniques. Examples of suitable alert indicators include audible indicators such as ring tones, vibratory alarms, and visual indicators such as lights or icons. If the called party 110 wishes to immediately answer the call, the called party 110 answers the call in accordance with known techniques. Examples of suitable techniques used to answer cellular telephones include depressing a “Send” button or opening a “flip phone” style telephone.

If the called party 110 wants to accept the call, but not immediately speak into the wireless device 102, the called party 110 can initiate the preliminary answer procedure. The preliminary answer procedure is invoked through a user interface such as a button, touch screen, touch pad, key, keyboard, microphone with voice recognition functionality, or any other suitable user interface on, connected to, or in communication with the wireless device 102. Suitable methods of initiating the preliminary answer procedure include depressing a button or selecting the preliminary answer procedure through a display. In some circumstances, the preliminary answer procedure can be initiated by selecting the procedure indicator displayed in a visual menu or by speaking the user input into the microphone of the wireless device 102. For example, with the use of an appropriate speech recognition mechanisms, the called party 110 may invoke the preliminary answer procedure by speaking the words “Hold call” into the microphone of the wireless device 102. In response to the preliminary answer user input provided by the called party 110, a preliminary answer indicator is produced and transmitted to a preliminary answer processor. As discussed below, the preliminary answer processor may be positioned in any one of several locations within the communication system 100 or may be distributed throughout the communication system 100.

In response to the preliminary answer indicator, the preliminary answer processor forwards a preliminary answer message to the calling device 104. The preliminary answer message includes an indication that a user (called party 110) of a wireless device 102 will participate in the call after a period of time. The preliminary answer message, therefore, may indicate that the called party is accepting the call but can not immediately engage in speech communication and will be able to communicate using the wireless device 102 after the period of time. The preliminary answer message may be a synthesized voice message, or recorded voice message, text message or any other message or indicator that indicates to the calling party that the called party 110 will participate in the call after a period of time. The called party 110, therefore, may answer the call, or otherwise accept the call, without engaging in verbal communication. The disruption of a meeting can be avoided or the called party 110 may minimize risk in a potentially dangerous situation by concentrating on a task requiring undivided attention such as driving a car while not missing the call.

The preliminary answer message is machine generated in the exemplary embodiment. In other words, the message is a played-back recorded message, a synthesized voice message, text, or other indicator that is retrieved from memory or created by any combination of hardware, software, firmware or other machine and is not directly produced by a person at the time the message is transmitted. In some situations, the preliminary answer message is a base band audio signal of audible speech that is modulated, processed and transmitted through the communication system 100 to the calling party where the signal is demodulated and processed to form the audible speech. In the exemplary embodiment, the preliminary answer message includes a recorded voice signal that is transmitted to the calling device 102. A suitable example of the preliminary answer message that includes a voice message is:

“Hello, this is Chuck. I have accepted your call and will speak with you in approximately thirty seconds.”

Alternatively or additionally, the preliminary answer can include a text message or a synthesized voice message that is transmitted to the calling device 104 such as:

“Chuck has accepted your call and will be on line in twenty seconds.”

The preliminary answer message can be generated at the wireless device 102, at any point within the communications network 106, or even at the calling device 104. For example, the preliminary answer indicator may be an electronic signal that, when received at the calling device 104, results in the playing of a recorded message on the calling device, the creation of an audio signal using speech synthesis or the illumination of an icon or light.

As mentioned above, the period of time may be programmed or set, or adjustably set by the user of the wireless device 102. For example, an application or mechanism on the wireless device 102 may allow a called party to configure the preliminary answer with a recorded voice message from the called party, and allow the called party to set the time period duration conveyed in the preliminary answer message. In some situations, the time period duration is conveyed directly by the preliminary answer message. Depending on the particular implementation, the time period may not be utilized for any other purpose than to indicate to the calling party when to expect the called party 110 to engage in communications. In some circumstances, however, the time period programmed by the called party 110 may be used to trigger other functions such as automatically answering the call, disconnecting the call, or inserting synthesized speech indicating the time period duration into the appropriate location with a preliminary answer message.

In the exemplary embodiment, the call is answered by the wireless device 102 when the preliminary answer procedure is initiated and the wireless device 102 is operable immediately after the preliminary answer message is forwarded to the calling device 102 and the call setup is complete. Therefore, in the exemplary embodiment, the appropriate exchange of signals through the wireless link 108 are performed in accordance with known techniques simultaneously, or nearly simultaneously, with the preliminary answer procedure. This allows the called party 110 to initiate voice communication with the calling party at any time after the preliminary answer message is sent.

In some circumstances, however, the preliminary answer procedure may be configured to place the wireless device 102 in a mute mode where the microphone and/or speaker is disabled until either the programmed time period has elapsed or the called party 110 has invoked an override instruction to answer the call. In some situations, the preliminary answer procedure may be configured to maintain the wireless device 102 in an “on-hook” mode where the call is not completed until the programmed time period has elapsed or the called party 110 has invoked an override instruction to answer the call. In such a situation, the call setup signaling is not initiated by the wireless device 102 until the programmed time period has elapsed or the called party 110 has invoked the override instruction. Upon expiration of the time period or in response to a command entered by the called party and after the call setup is complete, the wireless device 102 is operable for voice communication unless the preliminary answer time period is extended. The called party 110 may press the same or different button or key on the wireless device 102 to extend the original time period or start another time period for the preliminary answer. The time period may also be extended when speech is not detected after the expiration of the original period of time. If the period of time is extended, an extension indication may be transmitted to the calling device 104, including a description of the duration of the extended period of time after which the called party 110 of the wireless device 102 can audibly communicate.

In the exemplary embodiment, an advertisement message is presented to the calling party during the time period between the delivery of the preliminary answer message and the time the user begins communication. For example, the preliminary answer message may include:

“Jim will speak with you in fifteen seconds. Enjoy Smith's Cider during the holidays. ”

In some circumstances, the advertisement message may include descriptions of telephone numbers to call to receive more information about an offer. For example the advertisement message may include:

“Chuck has accepted your call. Stay on the line and Chuck will speak with you in fifteen seconds. Intercontinental Airlines has a special rate to the area you have called. Call 1-800-FLY-SOON.”

In some circumstances the calling party may be presented with options to receive additional information or to select an offer. For example, the advertisement message may include the following:

“Chuck has accepted your call. Stay on the line and Chuck will speak with you in fifteen seconds. Intercontinental Airlines has a special rate to the area you have called. Press ‘1’ if you would like an Intercontinental Airlines representative to call you later with details. Press ‘2’ if you would like to hear more options now.

Further, the options may include the option of disconnecting the call and accessing the promotion immediately. For example, the advertisement message may include the following:

“Chuck has accepted your call. Stay on the line and Chuck will speak with you in fifteen seconds. Intercontinental Airlines has a special rate to the area you have called. Press ‘1’ if you would like an Intercontinental Airlines representative to call you later with details. Press ‘2’ if you wish to end this call, hear more about the promotion and have Chuck call you back.”

In some circumstances, an option message may be provided without an advertisement. For example, the option message may include the following:

“Mark has accepted your call. Stay on the line and Mark will speak with you in fifteen seconds. Press ‘1’ if you would like to end this call and leave a voice mail message for Mark. Press ‘2’ if you wish to end this call and have an automatic call back in 1 minute from Mark's phone.”

Based on these teachings herein and known techniques, those skilled in the art will recognize the various embodiments, configurations of the communication system 100 and the combinations of preliminary answer messages, advertisement messages, and option messages.

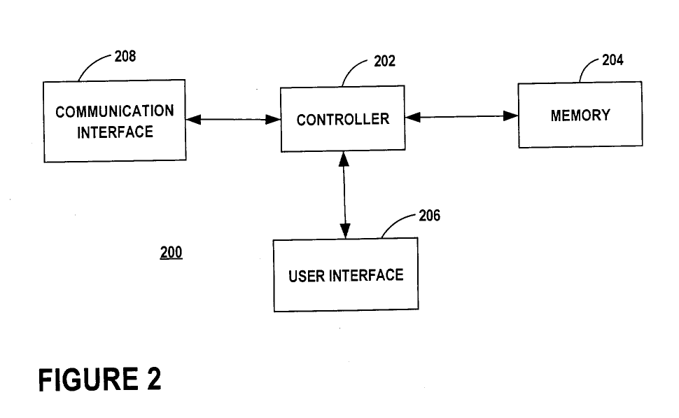

FIG. 2 is a block diagram of the preliminary answer processor 200 in accordance with the exemplary embodiment of the invention. The preliminary answer processor 200 may be implemented using any combination of hardware, software and firmware. Further, the preliminary answer processor 200 may be implemented in any one of the components within the communication system or distributed across multiple components of the communication system 100. For example, in one implementation of the exemplary embodiment, the preliminary answer processor 200 is implemented within each wireless device 102 providing the preliminary answer feature. In another implementation, a portion of the preliminary answer processor 200 is implemented in the wireless device 102 while another portion is implemented in a central office. Some or all of the functions described in connection with FIG. 2 may be implemented by modifying conventional software or hardware of components of the communication system 100. Also, the entire preliminary answer processor 200 or portions of the preliminary processor may be implemented in an integrated circuit (IC) or “chip”, application specific integrated circuit (ASIC) or other packaged device manufactured using semiconductor fabrication techniques.

The preliminary answer processor 200 includes at least a controller 202 and memory 204. The controller 202 may be a computer processor, microprocessor, processor arrangement, computer, personal computer or any other combination thereof. Software code running on the controller 202 performs functions described herein and, in some circumstances, facilitates the overall functionality of the preliminary answer processor 200 or other components. For example, if the preliminary answer processor 200 is implemented in a cellular phone, the controller 202 may be the microprocessor contained in the cellular phone and the software code running on the cellular phone processor may be configured or modified to perform the functions of the preliminary answer controller 202 as well as facilitating the overall functionality of the cellular phone.

The memory 204 is any type of memory medium suitable for storing at least one preliminary answer message. Where the preliminary answer processor 200 is implemented in a wireless device 102, an example of a suitable memory 204 is an integrated circuit memory. Where the memory 204 is located in a component within the communication system 100 other than the wireless device, the memory 204 should have sufficient capacity to store multiple preliminary answer messages correlated to the various wireless devices 104 serviced by the communication system 100. The memory 204 may be implemented across various devices with the communication system 100. Further, the information contained in the memory 204 may be duplicated in other memory devices. Such a redundancy may be useful to increase the robustness of the communication system 100 or to increase communication efficiencies through the communication network 106 and the communication system 100.

The user interface 206 is any device allowing the called party 102 to at least invoke the preliminary answer process. In the exemplary embodiment, the user interface allows the user to enter information for configuring and programming the preliminary answer process as well as allowing the called party 102 to invoke the preliminary answer process. Examples of a suitable user interfaces include displays, keypads and external push buttons on a cellular telephone. The user interface, however, may be any combination of touch screens, displays, lights, light emitting diodes (LEDs), speakers, tone generators, buttons, switches, keys, scrolling mechanisms, microphones, scanners, optical readers, computer mice, or keyboards. The preliminary answer user input entered through the user interface 202 by the called party 110 results in a preliminary answer indicator. An example of a suitable preliminary answer indicator is a dual tone multi-frequency (DTMF) signal generated when a key on a keypad is depressed.

The communication interface 208 is any combination of hardware and software that facilitates communication through components within the communication network 106 allowing the transmission of the preliminary answer message to the calling device. Where the communication interface 208 is implemented in a cellular telephone, for example, the communication interface 208 includes sufficient hardware and/or software to interface to the other cellular telephone circuitry to allow the transmission of the preliminary answer message though the wireless link 108. A suitable implementation in the cellular telephone includes circuitry and software to inject the analog base-band signal representing the preliminary answer message into the port of the circuitry where the cellular telephone accepts signals from the microphone. A switch may be used to temporarily disconnect the microphone and inject the preliminary answer message. Those skilled in the art will recognize the various implementations of the communication interface within the wireless device 102 or other components based on these teachings and known techniques.

When an incoming call is directed to a particular wireless device 102, the preliminary answer processor 200 receives a call indicator through the communication interface 208 and provides the call alert to the called user through the user interface 206. As discussed above, the call alert may be a ring tone, vibratory alarm, or other call alert. The called party 110 pushes a button, or otherwise invokes the preliminary answer process though the user interface 206. In response, the controller 202 retrieves the appropriate preliminary answer message from memory 204. If the preliminary answer processor 200 is implemented with the communication network 106, the controller 202 retrieves the preliminary answer message corresponding to the particular wireless device 102. A suitable method for correlating preliminary answer messages to wireless devices (102) includes using the unique telephone numbers to identify the appropriate preliminary answer message and storing the information in the same location as other called party preferences are stored in the wireless communication system.

The controller 202 forwards the preliminary answer message through the communication interface 208 to the calling device 104 where it is displayed, played, broadcast or otherwise conveyed to the calling party. In the exemplary embodiment, the preliminary answer message is audibly played through the speaker of the calling device 104.

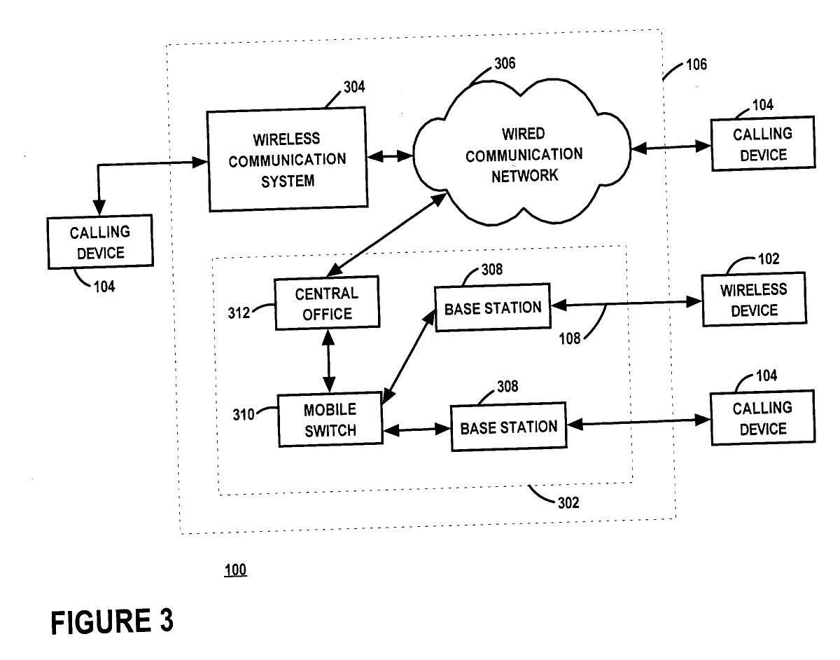

FIG. 3 is block diagram of the communication system 100 illustrating the wireless communication system portion 302 of the communication system 100 in accordance with the exemplary embodiment of the invention. The communication network 106 may include any number of systems, subsystems, networks, routers, hubs, switches, fiber optic cabling, wiring or other devices depending on the particular implementation. The communication network 106 includes at least one wireless communication system 302. In the exemplary embodiment, the communication network 106 includes wireless communication system 302, another wireless communication system 304 and a wired communication network 306. The communication network 106 is shown as a block with dashed lines to illustrate that the communication network 106 may include other wireless communication systems 304 or wired communication networks 306 or may be defined to include less than what is shown in FIG. 3. The communication network 106, therefore, may be defined to include as many or as few components as necessary to perform the functions described herein. For example, where the wireless device 102 and the calling device 104 are communicating with the same wireless communication system 302, the communication network 106 may coincide with the wireless communication system 302. If the controller 202 is contained in the mobile switch 310 servicing the both the wireless device 102 and the calling device 104, the communication network 106 may be defined to include the mobile switch 310 and the base stations 308 providing service to the wireless device 102 and the calling device 104.

The wireless communication system 302 is shown as a block with dashed lines to illustrate that the wireless communication system 302 may include other wireless communication systems 304 as well as additional components in some circumstances. The wireless communications system 302 is any wireless system or network providing voice communication services to wireless devices through a wireless link 108. Examples of suitable wireless systems 302 include, without limitation, cellular, personal communication service (PCS), wireless local area networks (WLAN) systems with voice capability and cordless telephone systems. In the exemplary embodiment, the wireless system 302 is a cellular communication system and the wireless device 102 is cellular telephone. Any number of additional wireless communication systems 304 may be connected within the communication network 106.

A wireless device 102 communicates with a base station 308 over a wireless link 108. The base station 308 provides wireless communication services to wireless devices within a cell. The base station 308 may include several subsystems or components such as amplifiers, antennas, transmitters, receivers and controllers. For example, in a wireless communication system 302 operating in accordance with the Global System for Mobile Communications (GSM) techniques, the base station 308 includes a base transceiver station (BTS), and base station controller (BSC) that are collectively known as a base station subsystem (BSS) in a GSM system.

A group of base stations 308 communicate with, and are managed by, a mobile switch 310, sometimes referred to as a mobile telephone switching office (MTSO) or a mobile services switching center (MSC). The mobile switch 310 is associated with, or includes, various communication databases, equipment, hardware and software. For example, in a GSM system, the mobile switch 308 hosts a home location register (HLR), a visitor location register (VLR), a equipment identity register (EIR), and an authentication center (AuC). The databases, hardware and software associated with the HLR, VLR, EIR, and AuC facilitate call processing tasks such as accessing customer information or processing roaming information. The mobile switch 310 is connected to communicate with a central office (CO) 312, to which any number of wired communication networks 306 may be connected, such as a public-switched telephone network (PSTN), integrated services digital network (ISDN), the Internet or an Intranet, or other another wireless communications systems 304. A calling device can call a wireless device 102 via any one of these networks. Those skilled in the art will readily recognize the various combination of components, and equipment to perform the function of the wireless communication system 302, the wired communication network 306 or other wireless communication systems 304 by applying the teachings herein in accordance with known techniques.

Those skilled in the art will recognize the similarities and differences between the various functional blocks and components in other types of wireless systems 302. Where the wireless communication system 304 operates in accordance with code division multiple access (CDMA) techniques for example, the wireless communication system 304 may include an MSC and several base stations. Where the wireless system 302 is a WLAN system operating in accordance with 802.11 standards, the wireless system may include wireless modems connected to a T1 line, internet, or telephone line, for example.

A calling party may place a call through the network 106 using a calling device 104 communicatively connected to the communication network 106 in any of several ways. For example, the calling device 104 may be in communication with a base station 108 in the same wireless communication system 302 providing communication services to the wireless device 102. The call may be placed through the same central office 312, the same mobile switch 310 or the same base station 308 that provides service to the wireless device 102.

Also, the calling device 104 may place a call through another wireless communication system 304 connected to the wireless communication system 302. For example, a calling device 104 may be a GSM cellular telephone connected to a GSM wireless communication system (304) in Spain that is connected through a wired communication network 306 to a wireless communication system 302 in the United States utilizing techniques in accordance with Code Division Multiple Access (CDMA). Further, the calling device 104 may be connected to a PSTN, Internet, or either wired system in the wired communication network 306.

The preliminary answer processor 202 may be implemented in the wireless devices 104, in any single component of the wireless communication system 302, in any component of the wired communication network 306, or across multiple components or systems. Where the preliminary answer processor is implemented in the wireless device 102, conventional communication infrastructure may remain unmodified. The controller 202, the memory 204 and the interfaces 206, 208 may all be contained within the wireless device 102. If the called party 110 wishes to utilize the preliminary answer feature, the called party 110 invokes the preliminary answer procedure. In response to the preliminary answer indicator, the controller 202 performs conventional call answering procedures while retrieving the preliminary answer message stored in memory, temporarily muting the microphone, and injecting a base band audio signal corresponding to the preliminary answer message into the audio circuitry of the wireless device 102. The preliminary answer message is processed, modulated and transmitted to the wireless device where the signal is demodulated, processed and played to the calling party through the calling device 104.

In some circumstances, the preliminary answer processor 200 may be implemented in one or more components of the wireless communication system 302. When the called party wishes to invoke the preliminary answer feature, the called party initiates the procedure by instructing the preliminary answer processor 202. In some implementations, the called party may depress a button that will generate the appropriate preliminary answer indicator to be transmitted through the wireless link 108 to the preliminary answer processor 200. A suitable technique includes answering the wireless device in a conventional manner and depressing a particular number on the key pad. For example, if the called party 110 wants to accept the call but can not engage in conversation immediately, the called party 102 may answer a cellular telephone and immediately depress the number “5” on the key pad. The transmitted touch tone associated with the key “5”, in this case, is the preliminary answer indicator. In response to receiving the preliminary answer indicator, the controller 202 in the preliminary answer processor 200 retrieves the appropriate preliminary answer message based on a unique identifier such as a serial number or telephone number. A memory 204 accessible by the controller includes the preliminary answer messages for each called party subscribing to the feature.

Accordingly, multiple preliminary answer messages may be stored for each called party where a particular touch tone is associated with each preliminary answer message for that user. For example, a particular user (called party 110) may invoke a first preliminary answer message stating that the called party will be available in 20 seconds by depressing “2” and may invoke a second preliminary answer message stating that the called party will be available in 50 seconds by depressing “5”. Those skilled in the art will recognize the various other combinations and variations of invoking the different messages based on these teachings.

The selection of the particular preliminary answer message may be based on other factors or criteria. The selection of the preliminary answer message, for example, may be at least partly based on a calling party identifier. The preliminary answer processor 200 may retrieve a particular preliminary answer message based on the caller ID of the calling party. For example, where a calling party is the spouse of the called party 110, the selected preliminary answer message may be less formal than if the caller ID indicates that the calling party is a business associate of the called party 110. Further, the selection of the particular preliminary answer message may be based on a combination of the caller ID and a user input. If, for example, the wireless device 102 is used by multiple users, the called party 110 may indicate which called party (110) is currently using the wireless device 102 and the preliminary answer processor 200 determines the appropriate preliminary answer message to use based on the user input and the caller ID or other criteria.

The memory 204 may be located anywhere in the system 100 depending on the particular implementation. A suitable location for the memory 204 includes the same location used for storing voice mail messages and other user data.

The controller 202 may be implemented in any one of the components within the wireless communication system or the wired communication network 306. An example of a suitable location includes the same location used in the particular system 100 for processing voice mail and other user functions for wireless subscribers (called parties 110).

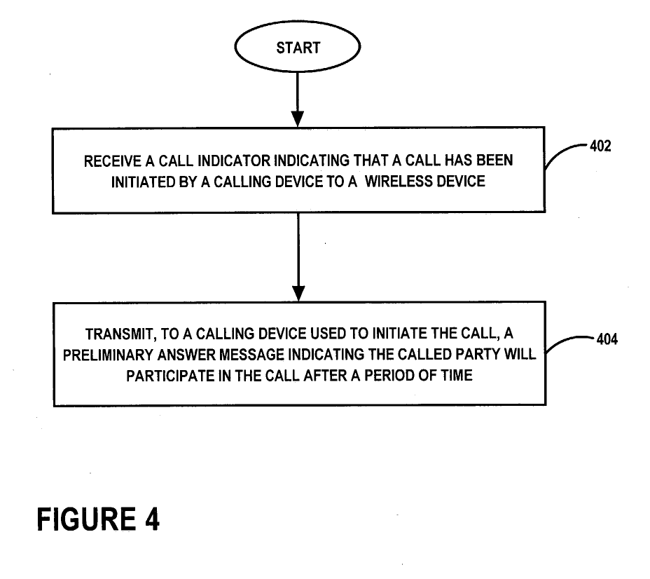

FIG. 4 is a flow chart of a method of managing incoming calls at a wireless device 102 in accordance with the exemplary embodiment. The method may be performed using any combination of hardware, software or firmware and may be performed in a single device, multiple devices or with multiple systems or subsystems. In the exemplary embodiment, the method is performed by the preliminary answer processor 200.

At step 402, a call indicator is received. The call indicator indicates a call has been initiated by the calling party through a calling device 104 to a wireless device 102. As discussed above, the call indicator is transmitted through the communication system 100 in accordance with known techniques and may include more than one signal.

At step 404, a preliminary answer message is transmitted to the calling device 104 indicating the called party 110 will participate in the call after a period of time. In the exemplary embodiment, the preliminary message is a machine-generated voice message, such as a recording, stating that the called party 110 will be available to communicate after a period of time. Although the preliminary answer message indicates that the called party 110 will participate in the call, the message does not necessarily indicate that the call has been setup or established. In some implementations, for example, the communication system 100 may receive an instruction (preliminary answer indicator) from the wireless device 102 indicating the called party 110 wishes to accept the call but may not complete the call until the period of time has elapsed.

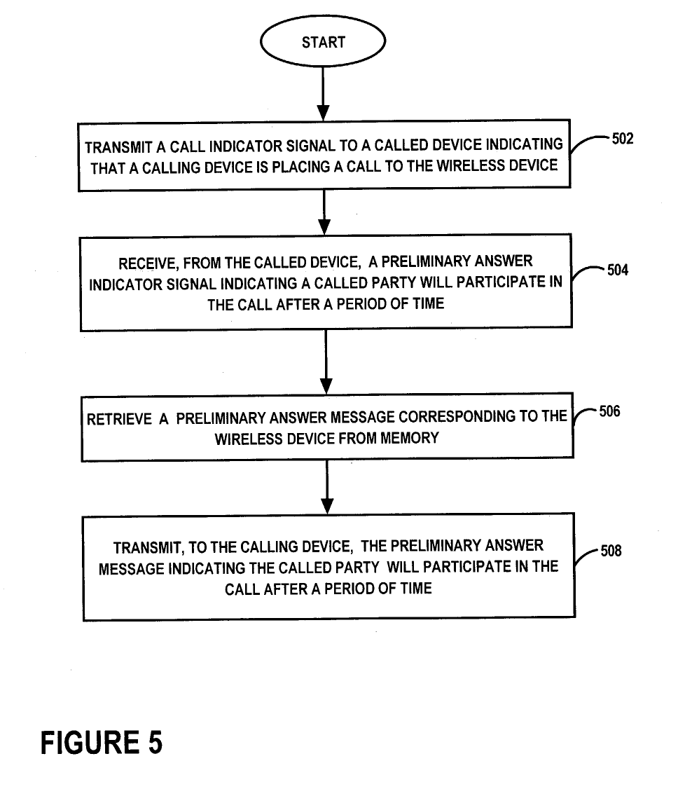

FIG. 5 is a flow chart of a method of managing incoming calls performed within the communication network 106 in accordance with an exemplary embodiment of the invention where at least a portion of the preliminary answer processor 200 is implemented within the communication network 106. The method may be performed using any combination of hardware, software or firmware and may be performed in a single device, multiple devices or within multiple systems or subsystems. An example of suitable technique for implementing the method includes running software code within the wireless communication system 302 on a processor, server, or other device used for processing voice mail and other user services.

At step 502, a call indicator is transmitted to the wireless device 102 indicating a calling device has placed a call to the wireless device 102. In the exemplary embodiment, known techniques for communicating the placement of the call to the wireless device 102 are applied.

A step 504, a preliminary answer indicator is received from the wireless device 102 indicating the called party 110 will participate in the call after a period of time. The preliminary answer indicator may be any type of audio signal, electrical signal or message. In the exemplary embodiment, the preliminary answer indicator is a Dual Tone Multi-Frequency (DTMF) signal generated at the wireless device 102 in response to a preliminary answer user input entered by the called party 110 through the user interface 206. The preliminary answer indicator may be audible speech in some situations. Where voice recognition functionality resides on the communication system 100, for example, the preliminary answer indicator may be the called party's voice stating “hold call” as discussed above.

At step 506, a preliminary answer message associated with the called party 110 is retrieved from memory 204. Based on a unique identifier, such as a telephone number of the wireless device 102, and the preliminary answer indicator, the controller 202 retrieves the appropriate preliminary answer message from memory 204. In some situations, the preliminary answer message may be one of several acceptable messages for the particular wireless device 102. Several preliminary answer messages may be stored and associated with a particular wireless device 102. The messages may include different time period durations conveyed in the message or may include messages conveying other information such as the circumstances surrounding the called party 110 at the particular moment. For example, a first preliminary answer message may indicate that the called party 110 is in a meeting and will engage in communication after ten seconds while a second preliminary answer message may indicate that the called party 110 is driving and will engage in conversation after one minute. The controller 202, therefore, retrieves the appropriate message as indicated by the preliminary answer indicator. Each of a plurality of keys of a wireless device keypad may be associated with a particular preliminary answer message.

At step 508, the preliminary answer message is transmitted to the calling device 104 indicating the called party 110 will participate in the call after a period of time. In the exemplary embodiment, the preliminary answer message includes speech stating that the called party is accepting the call and will communicate after a period of time as discussed above. Other types of preliminary answer messages, however, may be used depending on the particular implementation.

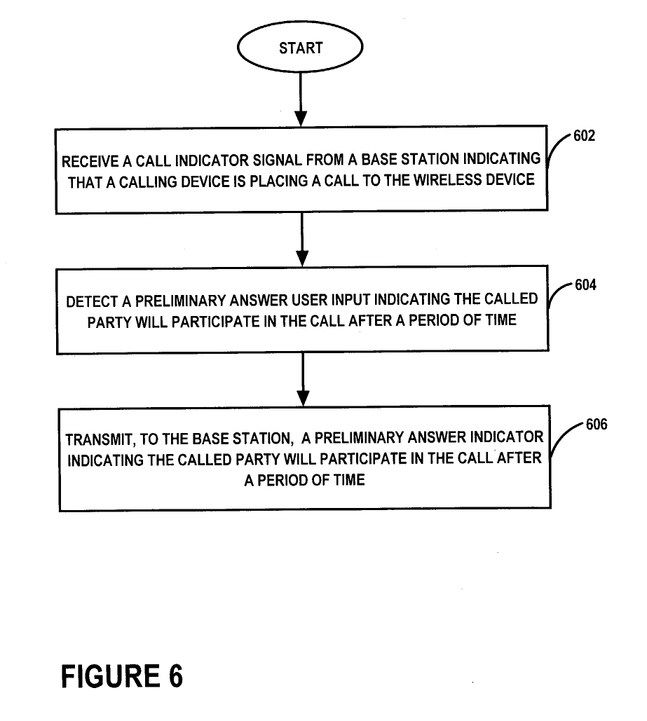

FIG. 6 is a flow chart of a method of managing incoming calls performed within the wireless device 102 in accordance with an exemplary embodiment of the invention where at least a portion of the preliminary answer processor 200 is implemented within the communication network 106. The method may be performed using any combination of hardware, software or firmware. An example of a suitable technique for implementing the method includes running software code on the processor or microprocessor within the wireless device 102.

At step 602, the wireless device 102 receives the call indicator from the base station 308 indicating a call has been placed to the wireless device 102 from the calling device 104. As discussed above, the call indicator is transmitted through the communication system 100 in accordance with known techniques and may include more than one signal.

At step 604, a preliminary answer user input is detected. The preliminary answer user input indicates the called party 110 will participate in the call after a period of time. The user input may indicate the called party's desire to accept the call, and their willingness to engage in communication after the period of time. As explained above, any of several user interfaces can be used by the called party 110 to enter a user input indicating that the called party 110 is accepting the call and intends to engage in communication after a period of time. In the exemplary embodiment, the called party uses the key pad on a wireless device to enter a number or set of numbers.

At step 606, the preliminary answer indicator is transmitted. The preliminary answer indicator indicates the call has been accepted and the called party will engage in communication after a period of time is transmitted to the base station 308. In the exemplary embodiment, the wireless device 102 generates a DTMF tone in response to the user input and transmits the signal through the communication interface 208 to indicate which preliminary answer message should be sent to the calling party.

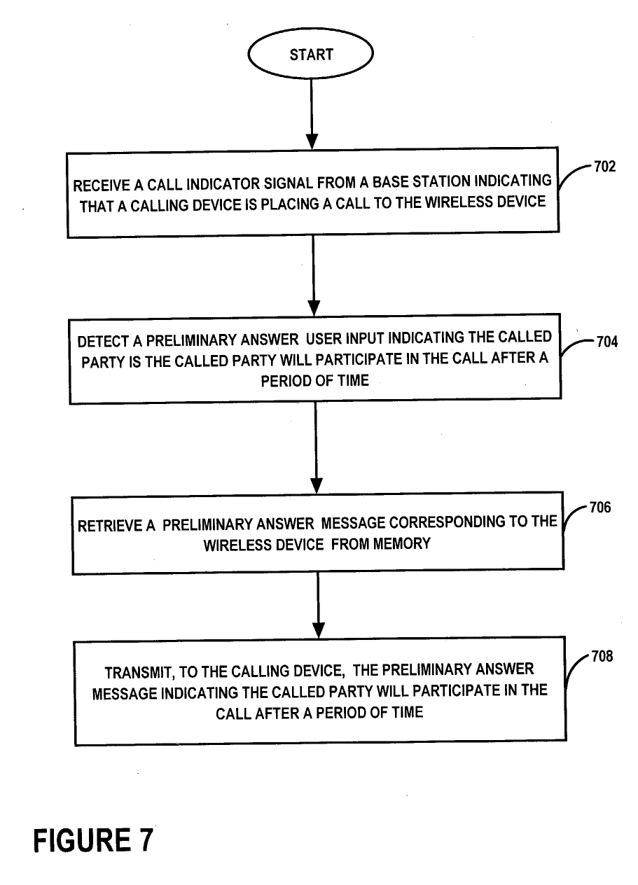

FIG. 7 is a flow chart of a method of managing incoming calls performed within the wireless device 102 in accordance with an exemplary embodiment of the invention where the preliminary answer processor 200 is implemented within the wireless device 102. The method may be performed using any combination of hardware, software or firmware. An example of a suitable technique for implementing the method includes running software code on the processor or microprocessor within the wireless device 102.

At step 702, the wireless device 102 receives the call indicator from the base station 308 indicating a call has been placed to the wireless device 102 from the calling device 104. As discussed above, the call indicator is transmitted through the communication system 100 in accordance with known techniques and may include more than one signal.

At step 704, a user input indicating the called party 110 will participate in the call after a period of time is detected. The called party 110 may indicate, therefore, the desire to accept the call with the willingness to engage in verbal communication after a period of time by entering the appropriate user input through the user interface 206. As explained above, any of several user interfaces (206) can be used by the called party 110 to enter a user input indicating that the called party 110 will participate in the call after a period of time. In the exemplary embodiment, the called party 110 uses the key pad on the wireless device 102 to generate DTMF tones creating the preliminary answer indicator.

At step 706, a preliminary answer message associated with the called party is retrieved from memory 204. Based on the user input, a preliminary answer indicator is forwarded to the controller 202 which retrieves the appropriate preliminary answer message from memory 204. In some situations, the preliminary answer message may be one of several acceptable messages for the particular wireless device 102. Several preliminary answer messages may be stored in the particular wireless device 102. The messages may include different time period durations conveyed in the message or may include messages conveying other information such as the circumstances surrounding the called party 110 at the particular moment. For example, a first preliminary answer message may indicate that the called party 110 is in a meeting and will engage in communication after ten seconds while a second preliminary answer message may indicate that the called party 110 is driving and will engage in conversation after one minute. The controller 202, therefore, retrieves the appropriate message as indicated by the preliminary answer indicator.

At step 708, the preliminary answer message is transmitted to the calling device 104 indicating the called party 110 will participate in the call after a period of time. In the exemplary embodiment, the preliminary answer message is a machine generated message including speech stating that the called party 10 is accepting the call and will communicate after a period of time as discussed above. Other types of preliminary answer messages, however, may be used depending on the particular implementation.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method comprising:
transmitting, to a calling device initiating a call to a wireless device of a called party, a machine-generated preliminary answer message indicating the called party will participate in the call after a period of time.

2. A method in accordance with claim 1, wherein the period of time is selectable by the called party.

3. A method in accordance with claim 1, wherein the preliminary answer message comprises a voice message.

4. A method in accordance with claim 3, wherein the preliminary answer message comprises a recorded human voice message.

5. A method in accordance with claim 3, wherein the preliminary answer message comprises a synthesized voice message.

6. A method in accordance with claim 1, wherein the preliminary answer message comprises an audible tone.

7. A method in accordance with claim 1, wherein the preliminary answer message results in a visual indicator on the calling device.

8. A method in accordance with claim 1, wherein the preliminary answer message is transmitted from the wireless device.

9. A method in accordance with claim 8, wherein the preliminary answer message is retrieved from memory within the wireless device.

10. A method in accordance with claim 1, wherein the preliminary answer message is transmitted in response to a user input indicating the called party is accepting the call and will engage in communication after the period of time.

11. A method in accordance with claim 1, wherein the preliminary answer message is transmitted from a wireless communication system communicating with the wireless device.

12. A method in accordance with claim 11, wherein the preliminary answer message is retrieved from memory within the wireless communication system.

13. A method in accordance with claim 1, further comprising transmitting, during the period of time, an advertisement to the calling device.

14. A method performed within a wireless communication system, the method comprising:
transmitting, to a wireless device of a called party, an indicator signal indicating a calling device is placing a call to the wireless device;
receiving, from the wireless device, a preliminary answer indicator indicating the called party will participate in the call after a period of time.

15. A method in accordance with claim 14, wherein the period of time is selectable by the called party.

16. A method in accordance with claim 14, further comprising:
transmitting, to the calling device, a preliminary answer message indicating the called party will participate in the call after a period of time.

17. A method in accordance with claim 16, wherein the preliminary answer message is a machine-generated preliminary answer message.

18. A method in accordance with claim 17, wherein the preliminary answer indicator is a dual tone multi-frequency (DTFM) signal.

19. A method in accordance with claim 17, wherein the preliminary answer message comprises a voice message.

20. A method in accordance with claim 19, wherein the preliminary answer message comprises a recorded human voice message.

21. A method in accordance with claim 19, wherein the preliminary answer message comprises a synthesized voice message.

22. A method in accordance with claim 17, wherein the preliminary answer message comprises an audible tone.

23. A method in accordance with claim 17, wherein the preliminary answer message results in a visual indicator at the calling device.

24. A method in accordance with claim 17, wherein the preliminary answer message is retrieved from memory within the wireless communication system.

25. A method in accordance with claim 14, further comprising transmitting, during the period of time, an advertisement to the calling device.

26. A method in accordance with claim 14, further comprising: providing menu information describing a plurality of calling options to the calling device.

27. A method in accordance with claim 26, further comprising: receiving a calling option instruction corresponding to one of the plurality of calling options.

28. A method performed in a wireless device, the method comprising:
receiving an incoming call indicator from a base station indicating a calling device is placing a call to the wireless device;
providing a call alert to alert a called party of the call;
transmitting a preliminary answer indicator to the base station indicating the called party will participate in the call after a period of time.

29. A method in accordance with claim 28, further comprising:
detecting a preliminary answer user input indicating the called party is accepting the call and will participate in the call after the period of time.

30. A method in accordance with claim 29, wherein detecting the preliminary answer user input comprises:
detecting a depression of a switch on the called wireless device.

31. A method in accordance with claim 30, wherein the detecting the depression of a switch comprises:
detecting a depression of a key on a keypad of the called wireless device.

32. A method in accordance with claim 31, wherein the preliminary answer indicator is a dual tone multi-frequency (DTMF) signal.

33. A method performed in a wireless device, the method comprising:
receiving an incoming call indicator from a base station indicating a calling device is placing a call to the wireless device of a called party;
providing a call alert to the called party;
transmitting a preliminary answer message to the base station indicating the called party will participate in the call after a period of time.

34. A method in accordance with claim 33, further comprising:
detecting a preliminary answer user input indicating the called party is accepting the call and will participate in the call after a period of time.

35. A method in accordance with claim 34, further comprising:
retrieving from memory within the wireless device the preliminary answer message.

36. A method in accordance with claim 34, wherein detecting the preliminary answer user input comprises:
detecting a depression of a switch on the called wireless device.

37. A method in accordance with claim 36, wherein the detecting the depression of a switch comprises:
detecting a depression of a key on a keypad of the called wireless device.

38. A method in accordance with claim 33, wherein the period of time is selectable by the called party.

39. A method in accordance with claim 33, wherein the preliminary answer message is a machine-generated preliminary answer message.

40. A method in accordance with claim 33, wherein the preliminary answer message comprises a voice message.

41. A method in accordance with claim 40, wherein the preliminary answer message comprises a recorded human voice message.

42. A method in accordance with claim 40, wherein the preliminary answer message comprises a synthesized voice message.

43. A method in accordance with claim 33, wherein the preliminary answer message comprises an audible tone.

44. A method in accordance with claim 33, wherein the preliminary answer message results in a visual indicator on the calling device.

45. A method in accordance with claim 33, further comprising transmitting, during the period of time, an advertisement to the calling device.

46. A method of managing an incoming call at a wireless device, the method comprising:
receiving an incoming call indicator from a base station indicating a calling device is placing a call to the wireless device;
providing a call alert to a called party of the call;
detecting a preliminary answer user input indicating the called party will participate in the call after a period of time;
retrieving from memory within the wireless device, a preliminary answer message; and
transmitting the preliminary answer message to the base station indicating the called party will participate in the call after a period of time.

47. A method in accordance with claim 46, wherein the preliminary answer message is a recorded voice message.

48. A method in accordance with claim 46, wherein the preliminary answer message is a synthesized voice preliminary answer message and the transmitting the preliminary answer message comprises synthesizing a voice message based on the preliminary answer message retrieved from memory to form the synthesized voice preliminary answer message.

49. A controller comprising circuitry for executing programmed instructions comprising:
transmitting, to a calling device used to initiate a call to a called wireless device of a caller party, a preliminary answer message indicating the called party will participate in the call after a period of time.

50. A controller in accordance with claim 49, wherein the period of time is selectable by the called party.

51. A controller in accordance with claim 49, wherein the preliminary answer message comprises a voice message.

52. A controller in accordance with claim 51, wherein the preliminary answer message comprises a recorded human voice message.

53. A controller in accordance with claim 51, wherein the preliminary answer message comprises a synthesized voice message.

54. A controller in accordance with claim 49, wherein the preliminary answer message comprises an audible tone.

55. A controller in accordance with claim 49, wherein the preliminary answer message results in a visual indicator on the calling device.

56. A controller in accordance with claim 49, wherein the preliminary answer message is transmitted from the wireless device.

57. A controller in accordance with claim 56, wherein the instructions comprise retrieving the preliminary answer message from memory within the wireless device.

58. A controller in accordance with claim 49, wherein the instructions comprise transmitting the preliminary answer message in response to a user input indicating the called party will participate in the call after the period of time.

59. A controller in accordance with claim 49, wherein the instructions comprise transmitting the preliminary answer message from a wireless communication system communicating with the called wireless device.

60. A controller in accordance with claim 59, wherein the instructions comprise retrieving the preliminary answer message from memory within the wireless communication system.

61. A controller in accordance with claim 49, wherein the instructions further comprising transmitting, during the period of time, an advertisement to the calling device.

62. A controller comprising circuitry for executing programmed instructions comprising:
receiving a preliminary answer indicator indicating a called party will participate in a call initiated through a calling device after a period of time;
retrieving from memory a preliminary answer message indicating the called party will participate in the call after the period of time;
transmitting, to the calling device, the preliminary answer message indicating the called party will participate in the call after a period of time.

63. A controller in accordance with claim 62, wherein the preliminary answer message is a recorded voice message.

64. A controller in accordance with claim 62, wherein the preliminary answer indicator is received from a user interface.

65. A controller in accordance with claim 64, wherein the period of time is received through the user interface.

66. An apparatus for managing an incoming call at a wireless device, the apparatus comprising:
a user interface for receiving a preliminary answer user input and generating a preliminary answer indicator indicating a called party will participate in the call after a period of time;
a controller for retrieving a preliminary answer message from a memory in response to the preliminary answer indicator; and
a communication interface for transmitting the preliminary answer message through a communication network to a calling device initiating the call.

67. An apparatus in accordance with claim 66, wherein the preliminary answer user input is a selection of a key and the preliminary answer indicator is a dual tone multi-frequency (DTMF) signal.

68. An apparatus in accordance with claim 66, wherein the preliminary answer message is a recorded voice message.

69. An apparatus in accordance with claim 66, further comprising the memory.

70. An apparatus in accordance with claim 66, wherein the user interface is further for receiving the period of time.

71. A wireless communication system comprising:
a base station for providing wireless communication services through a wireless link to a called wireless device and for transmitting a call indicator indicating a calling device is placing a call to the called wireless device;
a central office responsive to receiving a preliminary answer indicator from the called wireless device through the base station and for transmitting a preliminary answer message indicating a called party will participate in the call after a period of time.

72. A wireless communication system in accordance with claim 71, further comprising a memory for storing the preliminary answer message, the controller for retrieving the preliminary answer message from the memory.

73. A wireless communication system in accordance with claim 71, wherein the preliminary answer indicator is a dual tone multi-frequency (DTMF) signal initiated by a preliminary answer user input entered through a user interface of the called wireless device.

74. A wireless communication system in accordance with claim 73, wherein the user interface is further for receiving the period of time.

75. A wireless communication system in accordance with claim 71, wherein the preliminary answer message is a recorded voice message.

76. A wireless device comprising:
a communication interface for communicating through a wireless communication system with a calling device initiating a call to a called party of the wireless device;
a memory for storing a preliminary answer message indicating the called party will participate in the call after a period of time;
a controller for retrieving the preliminary answer message from memory and transmitting the preliminary answer message to the calling device through the communication interface.

77. A wireless device in accordance with claim 76, further comprising a user interface for detecting a preliminary answer user input indicating the called party will participate in the call after the period of time.

78. A communication system comprising:
a calling device;
a wireless device; and
a communication network for transmitting a call indicator to the wireless device when a call is placed from the calling device to the wireless device, the communication system configured to transmit, to the calling device, a machine-generated preliminary answer message indicating a called party will participate in the call after a period of time.
